(19) United States
(12) Patent Application Publication
(10) Pub. No.: US 2025/0388210 A1
(43) Pub. Date: Dec. 25, 2025

(54) SYSTEM FOR COLLISION DETECTION

(71) Applicant: Torc Robotics, Inc., Blacksburg, VA (US)

(72) Inventor: Thejus Jose, Austin, TX (US)

(21) Appl. No.: 18/749,000

(22) Filed: Jun. 20, 2024

(51) Int. Cl. B60W 30/09; B60W 30/095; B60W 60/00; G06V 10/762

(52) U.S. Cl. CPC B60W 30/09; B60W 30/0956; B60W 60/0015; G06V 10/762; B60W 2300/14

(57) ABSTRACT

A system for collision detection is provided. The system includes one or more sensors associated with a vehicle, the one or more sensors configured to detect an obstacle around the vehicle. The system includes a processing device that generates a vehicle shape representative of and encompassing the vehicle, identifies a centroid of the vehicle shape, generates an obstacle shape representative of and encompassing the obstacle, and generates an inflated obstacle boundary based on dimensions of the vehicle shape. The inflated obstacle boundary is dimensioned greater than the obstacle shape. The inflated obstacle boundary represents a path along which the centroid of the vehicle shape can move without collision between the vehicle and the obstacle.

### TECHNICAL FIELD

The field of the disclosure relates to collision detection and, in particular, to a system for collision detection for an autonomous vehicle in all instances, including when the vehicle is at a non-parallel and non-perpendicular angle relative to the detected obstacle, to allow for mapping of free space in which the autonomous vehicle can travel without a collision.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

One aspect of planning technologies is detecting collisions between obstacles or objects around the autonomous vehicle in order to make control decisions to avoid such collisions between the autonomous vehicle and any surrounding obstacles on the road. Conventional collision detection algorithms typically check for intersections between polygons and may rely on checking for intersections of numerous lines, which results in increased time for determining what is needed to avoid an obstacle. Such conventional collision detection algorithms can take a prohibitively long amount of computation time. Conventional algorithms for autonomous driving applications generally rely on an assumption that the vehicle always remains roughly parallel to the road, even when changing lanes, and the obstacle is similarly positioned parallel to the vehicle. (See, e.g., McNaughton, M. et al., Motion Planning for Autonomous Driving with a Conformal Spatiotemporal Lattice, 2011 IEEE International Conference on Robotics and Automation (2011)).

Accordingly, there exists a need for a system and a method of collision detection for an autonomous vehicle to avoid collisions with such obstacles. These and other needs are met by the exemplary system for collision detection discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for collision detection is provided. The system includes one or more sensors associated with a vehicle. The one or more sensors is configured to detect an obstacle around the vehicle. The system includes a processing device in communication with the one or more sensors. The processing device is configured to execute instructions stored in a memory to perform operations for obstacle detection. The operations includes generating a vehicle shape representative of and encompassing the vehicle, identifying a centroid of the vehicle shape, generating an obstacle shape representative of and encompassing the obstacle, and generating an inflated obstacle boundary based on dimensions of the vehicle shape. The inflated obstacle boundary is dimensioned greater than the obstacle shape. The inflated obstacle boundary represents a path along which the centroid of the vehicle shape can move without collision between the vehicle and the obstacle. The points along which the vehicle can travel without collision between the vehicle and the obstacle represent “free space” available on the road. The vehicle’s planning subsystem uses the detected free space to generate a motion plan for the vehicle in which the vehicle can drive through without colliding with surrounding obstacles.

The vehicle is at a non-parallel and non-perpendicular angle relative to the detected obstacle, and the system can successfully generate the inflated obstacle boundary to avoid any surrounding obstacles. It should be understood that the system could similarly be used for a vehicle that is parallel or perpendicular relative to the detected obstacle. In some embodiments, the vehicle can be a single body vehicle. In some embodiments, the vehicle can be a multi-body vehicle including a tractor and a trailer.

The vehicle shape can be represented as a vehicle rectangle or square including a top edge and an opposing bottom edge defining a width, and a left edge and an opposing right edge defining a length. The shape of the vehicle itself may not be rectangular or square. However, the system can generate a rectangular or square representation for the vehicle, with the shape creating a boundary that encompasses the vehicle in its entirety. The obstacle shape can be represented as an obstacle rectangle or square including a top edge and an opposing bottom edge defining a width, a left edge and an opposing right edge defining a length, and a vertex at each corner of the obstacle rectangle or square. Similar to the vehicle, the actual obstacle shape may not be rectangular or square. However, the obstacle shape generated by the system is intended to create a boundary encompassing the entirety of the obstacle for purposes of generating the inflated obstacle boundary.

Generating the inflated obstacle boundary can include transposing a first set of lines having a dimension of half the width and extending in a direction parallel to the top and bottom edges of the vehicle rectangle or square from each vertex of the obstacle rectangle or square, and connecting endpoints of the first set of lines with a boundary of the obstacle shape to represent a first part of the inflated obstacle boundary. Generating the inflated obstacle boundary can include transposing a second set of lines having a dimension of half the width and extending in the direction parallel to the top and bottom edges of the vehicle rectangle or square from each vertex of the obstacle rectangle or square. The second set of lines extend from the vertex away from the respective first set of lines. Generating the inflated obstacle boundary can further include connecting endpoints of the second set of lines with the first part of the inflated obstacle boundary to represent a second part of the inflated obstacle boundary.

Generating the inflated obstacle boundary can include transposing a third set of lines having a dimension of half the length and extending in a direction parallel to the left and right edges of the vehicle rectangle or square from each vertex of the second part of the inflated obstacle boundary, and transposing a fourth set of lines having a dimension of half the length and extending in a direction parallel to the left and right edges of the vehicle rectangle or square from each vertex of the second part of the inflated obstacle boundary. The fourth set of lines extend from the vertex away from the respective third set of lines. Generating the inflated obstacle boundary can include connecting endpoints of the third and fourth set of lines with the second part of the inflated obstacle boundary to represent the inflated obstacle boundary.

If the vehicle is a single body vehicle, the operations include generating the inflated obstacle boundary based on only the vehicle shape. If the vehicle is a multi-body vehicle, the operations include generating the vehicle shape for each body of the multi-body vehicle, generating the inflated obstacle boundary based on each vehicle shape, and combining the inflated obstacle boundaries based on each vehicle shape to generate a multi-body inflated obstacle boundary.

If the vehicle is a multi-body vehicle, generating the vehicle shape includes generating a first vehicle shape for a first section of the multi-body vehicle and generating a second vehicle shape for a second section of the multi-body vehicle. Each of the first vehicle shape and the second vehicle shape can be a vehicle rectangle or square including a top edge and an opposing bottom edge defining a width, and a left edge and an opposing right edge defining a length. The obstacle shape can be an obstacle rectangle or square including a top edge and an opposing bottom edge defining a width, a left edge and an opposing right edge defining a length, and a vertex at each corner of the obstacle rectangle or square.

If the vehicle is a multi-body vehicle, the centroid can be located at an intersection or connection of the first vehicle shape and the second vehicle shape. If the vehicle is the multi-body vehicle, generating the inflated obstacle boundary can include generating a first inflated obstacle boundary based on the first vehicle shape, generating a second inflated obstacle boundary based on the second vehicle shape, and combining the first and second inflated obstacle boundaries to generate a multi-body inflated obstacle boundary.

Generating the first inflated obstacle boundary can include transposing a first set of lines having a dimension of half the width of the first vehicle shape and extending in a direction parallel to the top and bottom edges of the vehicle rectangle or square for the first vehicle shape from each vertex of the obstacle rectangle or square. Generating the first inflated obstacle boundary can include connecting endpoints of the first set of lines with a boundary of the obstacle shape to represent a first part of the first inflated obstacle boundary. Generating the first inflated obstacle boundary can include transposing a second set of lines having a dimension of the width of the first vehicle shape and extending in the direction parallel to the top and bottom edges of the vehicle rectangle or square for the first vehicle shape from each vertex of the obstacle rectangle or square. The second set of lines extend from the vertex away from the respective first set of lines. Generating the first inflated obstacle boundary can include connecting endpoints of the second set of lines with the first part of the first inflated obstacle boundary to represent a second part of the first inflated obstacle boundary.

Generating the first inflated obstacle boundary can include transposing a third set of lines having a dimension of the length of the first vehicle shape and extending in a direction parallel to the left and right edges of the vehicle rectangle or square for the first vehicle shape from each vertex of the second part of the first inflated obstacle boundary. Generating the first inflated obstacle boundary can include connecting endpoints of the third set of lines with the second part of the first inflated obstacle boundary to represent the first inflated obstacle boundary.

Generating the second inflated obstacle boundary can include transposing a first set of lines having a dimension of half the width of the second vehicle shape and extending in a direction parallel to the top and bottom edges of the vehicle rectangle or square for the second vehicle shape from each vertex of the obstacle rectangle or square, and connecting endpoints of the first set of lines with a boundary of the obstacle shape to represent a first part of the second inflated obstacle boundary. Generating the second inflated obstacle boundary can include transposing a second set of lines having a dimension of the width of the second vehicle shape and extending in the direction parallel to the top and bottom edges of the vehicle rectangle or square for the second vehicle shape from each vertex of the obstacle rectangle or square. The second set of lines extend from the vertex away from the respective first set of lines. Generating the second inflated obstacle boundary can include connecting endpoints of the second set of lines with the first part of the second inflated obstacle boundary to represent a second part of the second inflated obstacle boundary.

Generating the second inflated obstacle boundary can include transposing a third set of lines having a dimension of the length of the second vehicle shape and extending in a direction parallel to the left and right edges of the vehicle rectangle or square for the second vehicle shape from each vertex of the second part of the second inflated obstacle boundary. Generating the second inflated obstacle boundary can include connecting endpoints of the third set of lines with the second part of the second inflated obstacle boundary to represent the second inflated obstacle boundary.

The operations can include generating a buffer zone along a perimeter of the inflated obstacle boundary. The buffer zone can be an area offset perpendicularly from each side of the inflated obstacle boundary by a predetermined distance away from the obstacle. The operations can include setting a border of the buffer zone as a limit for travel of the centroid of the vehicle shape to avoid the collision between the vehicle and the obstacle. The operations can include setting or adjusting a motion path of the vehicle to avoid entering or passing of the centroid of the vehicle shape through the inflated obstacle boundary to avoid the collision between the vehicle and the obstacle.

In another aspect, an exemplary computer-implemented method for collision detection is provided. The method includes detecting an obstacle around a vehicle with one or more sensors associated with the vehicle. The method includes executing instructions stored in a memory with a processing device in communication with the one or more sensors to perform operations for obstacle detection. The operations include generating a vehicle shape representative of and encompassing the vehicle, identifying a centroid of the vehicle shape, generating an obstacle shape representative of and encompassing the obstacle, and generating an inflated obstacle boundary based on dimensions of the vehicle shape. The inflated obstacle boundary is dimensioned greater than the obstacle shape. The inflated obstacle boundary represents a path along which the centroid of the vehicle shape can move without collision between the vehicle and the obstacle.

In yet another aspect, an exemplary non-transitory computer-readable medium storing instructions for collision detection that are executable by a processing device is provided. Execution of the instructions by the processing device causes the processing device to detect an obstacle around a vehicle with one or more sensors associated with the vehicle, generate a vehicle shape representative of and encompassing the vehicle, identify a centroid of the vehicle shape, generate an obstacle shape representative of and encompassing the obstacle, and generate an inflated obstacle boundary based on dimensions of the vehicle shape. The inflated obstacle boundary is dimensioned greater than the obstacle shape. The inflated obstacle boundary represents a path along which the centroid of the vehicle shape can move without collision between the vehicle and the obstacle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck.

FIG. 2 is a block diagram of the autonomous truck shown in FIG. 1.

FIG. 3 is a block diagram of an example computing system.

FIGS. 4A-4E are diagrammatic views of a conventional obstacle boundary generation.

FIG. 5 is a block diagram of an exemplary system for collision detection.

FIG. 6 is a flowchart of a method for collision detection.

FIG. 7 is a diagrammatic view of an obstacle and a single-body vehicle positioned in a non-parallel and non-perpendicular orientation relative to the obstacle.

FIGS. 8A-8F are diagrammatic views of steps of generating an inflated obstacle boundary with an exemplary system for collision detection.

FIG. 9 is a diagrammatic view of an inflated obstacle boundary generated by an exemplary system for collision detection for the single-body vehicle of FIG. 7.

FIG. 10 is a diagrammatic view of an obstacle and a multi-body vehicle positioned in a non-parallel and non-perpendicular orientation relative to the obstacle.

FIGS. 11A-11H are diagrammatic views of steps of generating an inflated obstacle boundary with an exemplary system for collision detection.

FIG. 12 is a diagrammatic view of an inflated obstacle boundary generated by an exemplary system for collision detection for the multi-body vehicle of FIG. 10.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Centroid: A centroid, as the term is used herein, is any point selected on the vehicle or obstacle for purposes of generating the inflated obstacle boundary. The centroid does not need to be the same as a mathematical centroid of the shape, and instead can be any point selected by the system for purposes of calculating the inflated obstacle boundary. Thus, the centroid can be in the middle of the rectangular or square representation used for the vehicle and obstacle, or can be any other point on the representation, so long as the obstacle generation algorithm is used as discussed herein.

The exemplary system for collision detection discussed herein allows for a faster and more accurate determination of an obstacle boundary for avoiding a collision with an autonomous vehicle. The system is capable of accurately generating an obstacle boundary for both single-body vehicles and multi-body vehicles, and vehicles that are in a non-parallel and non-perpendicular orientation relative to the obstacle (although the system could be used similarly for parallel/perpendicular orientations as well).

Although discussed herein as generating an obstacle boundary in a two-dimensional (2D) representation associated with the sides and front/rear of the vehicle and/or obstacle (e.g., “x” and “y” directions), in some embodiments, the system could be similarly used to generate an obstacle boundary in a three-dimensional (3D) representation. For example, a substantially similar algorithm and process could be used to detect obstacles above and/or below the vehicle, with the steps performed by the algorithm expanded into a “z” direction.

The calculations performed by the system can occur, e.g., continuously, when sensors of the vehicle detect an object or obstacle within a predetermined perimeter, any time the vehicle plans to make a motion change such as a turn, acceleration, or deceleration, combinations thereof, or the like. In some embodiments, the system performs the collision checking calculations multiple times each second, e.g., continuously. At each sampling point, the system checks for potential collisions with other objects. Because an autonomous vehicle makes these types of decisions frequently, reducing the time for collision checking is essential for accurate and efficient operation of the vehicle. The exemplary system allows for such efficient and accurate collision checking determinations while the system runs continuously as part of the operational control associated with the vehicle.

The system removes assumptions of conventional collision checking algorithms. Specifically, the vehicle does not need to be parallel to the road or the obstacle. Instead, the system is capable of detecting an obstacle and performing the collision checking algorithm to generate an inflated obstacle boundary using any vehicle or obstacle orientation. The system expands a polygon into a larger polygon (e.g., a convex polygon) for generating the inflated obstacle boundary. The obstacle boundary generated by the system is used as input to the processing device associated with the vehicle to control decision-making for movement of the vehicle. For example, if the system determines that no collision will occur, the vehicle can be actuated to move in the intended manner. However, if the system determines that a collision will occur, the path for the vehicle is adjusted to avoid the obstacle collision. Based on the input, the vehicle can similarly be actuated to, e.g., accelerate, decelerate, change lanes, stop completely, or the like.

For efficiency in determining the obstacle boundary, the system assigns a rectangular or square shape to the obstacle and the vehicle. Thus, for any obstacle or vehicle, the system generates a rectangular or square shape, with the size of the shape dimensioned to ensure that all aspects of the obstacle or vehicle fit within the boundaries of the shape. The system can thereby be used for generating an obstacle boundary for any vehicle type, with the assumption that any such vehicle can be enclosed by a rectangle or square representation. This allows for the system to be used in any instance and for any vehicle, providing flexibility in incorporation into various autonomous vehicles.

The inflated obstacle boundary generated by the system can represent the minimum distance needed relative to the obstacle to avoid a collision with the vehicle. The system incorporates a buffer distance around the perimeter of the inflated obstacle boundary to ensure the vehicle maintains a greater distance away from the obstacle, thereby ensuring the collision is avoided. The overall shape of the polygon generated as the inflated obstacle boundary remains the same, although the size increases with the buffer. The dimensions of the buffer can vary depending on multiple factors, e.g., the type of object, the location of the object relative to the vehicle, the speed of the vehicle, or the like. For example, if the object is a pedestrian or another vehicle, a 5-10 m buffer can be used on all sides of the boundary. As another example, if the object is detected in front of the vehicle, a greater buffer can be used as compared to if the object was detected on the side of the vehicle (e.g., due to greater collision danger in front or behind the vehicle). As another example, the higher the speed of the vehicle, the greater the buffer to accommodate more space for decision-making to avoid a collision. In some embodiments, the buffer can rely on standard regulations for driving, e.g., distance to maintain between front of autonomous vehicle and other vehicles while traveling at certain speeds, or the like.

Obstacles on the road are detected by sensors of the vehicle and/or the perception subsystem of the vehicle, and transmitted to a path planning subsystem. The path planning subsystem samples different points on the road and uses the exemplary system/algorithm to determine whether the autonomous vehicle would be in collision with any obstacle at any of the sampled points. The sampled points which are found to not be in collision with the obstacle represent the free space available to the autonomous vehicle on the road, and are used to plan a safe and collision-free path for the autonomous vehicle. Thus, in addition to detecting obstacles, the system allows for mapping out of the free space available on the road for the autonomous vehicle to drive in.

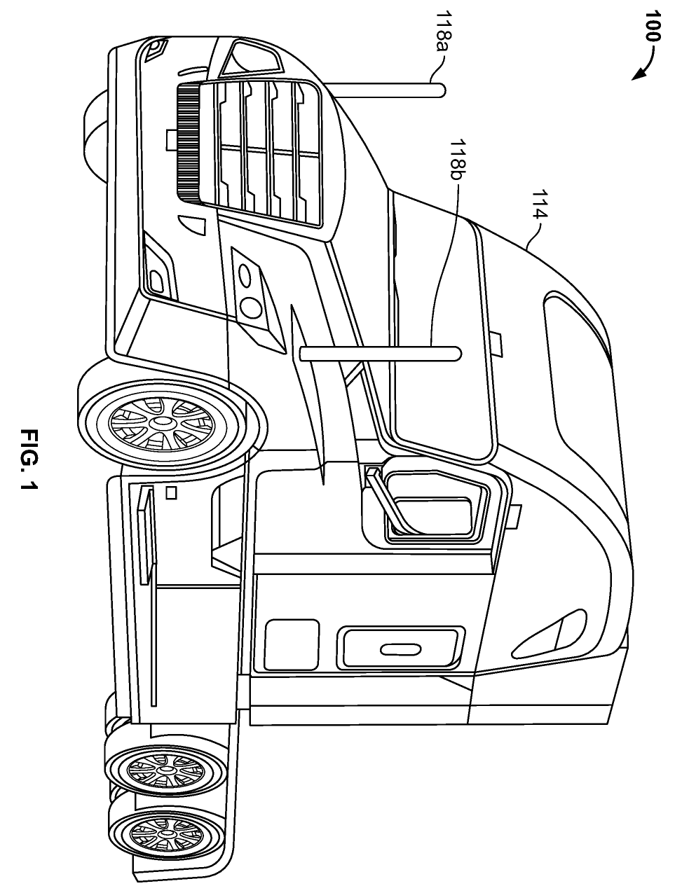

Various embodiments in the present disclosure are described with reference to FIGS. 1-12 below.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors. For example, the vehicle 100 can include one or more antenna 118a, 118b at or near the front of the vehicle 100 with sensors having a field-of-view at the front and/or sides of the vehicle 100.

Similar sensors can be used around the perimeter of the vehicle 100 to ensure full environmental coverage around the vehicle 100 is provided by the sensors. In some embodiments, the vehicle 100 can include, e.g., 5-6 LIDAR sensors, 8-10 cameras, combinations thereof, or the like. In some embodiments, the vehicle 100 can tow a trailer and the trailer can similarly include LIDAR sensors and/or cameras to provide field-of-view coverage around the perimeter of the vehicle 100 and the trailer. The environmental coverage by the sensors and/or cameras therefore provides data corresponding with the front, rear, sides and corners of the vehicle 100 and the trailer hauled by the vehicle 100.

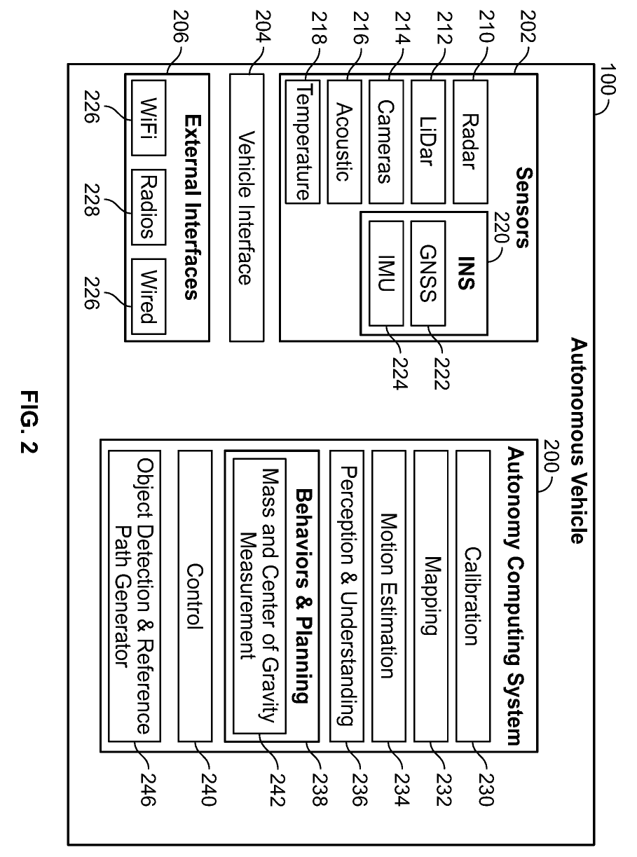

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

In some embodiments, the image data generated by cameras 214 may be transmitted to mission control for one or more of identifying one or more construction markers (or nodes), generating one or more connectivity graphs based upon identified construction markers (or nodes), updating a reference path based upon the one or more connectivity graphs, transmitting the updated reference path to the autonomy vehicle 100 for guiding autonomous vehicle 100 to drive on the updated reference path.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 246 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

FIG. 3 is a block diagram of an example computing system 300, such as the autonomy computing system 200 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

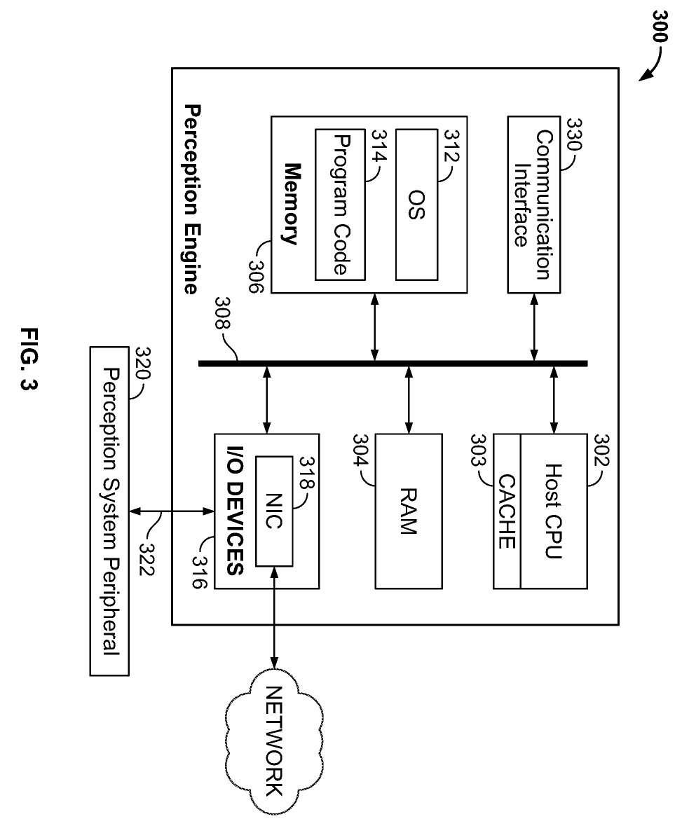

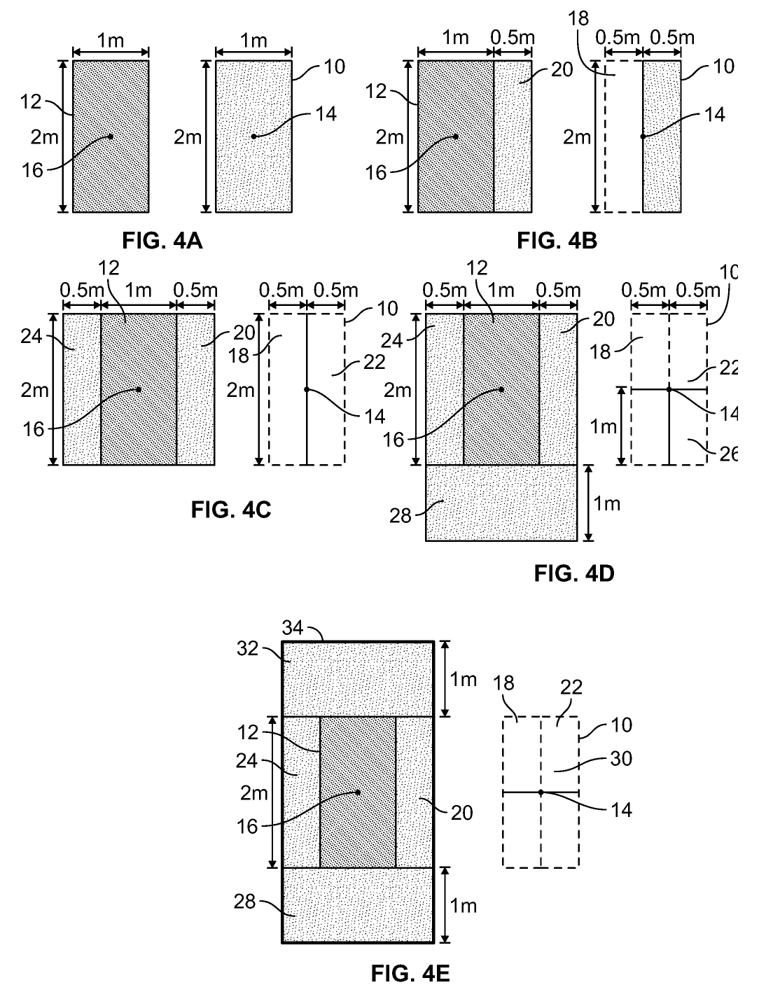

FIGS. 4A-4E are diagrammatic views illustrating how a conventional obstacle boundary is generated. Such conventional process is based on the underlying assumption that the vehicle 10 and obstacle 12 are both parallel to a road, and are therefore parallel to each other. The conventional process cannot be accurately used to generate an obstacle boundary for vehicles 10 and obstacles 12 that are in a non-parallel and non-perpendicular orientation relative to each other.

A rectangular shape is selected to represent the vehicle 10 and the obstacle 12. The vehicle 10 and the obstacle 12 are assigned a respective centroid 14, 16. Although the centroids 14, 16 are in the middle of the rectangles representative of the vehicle 10 and obstacle 12, it should be understood that the centroids 14, 16 can be selected anywhere within the rectangles. In the conventional process, the obstacle 12 is inflated in a rectangular pattern complimentary to the shape of the vehicle 10.

In the process, a first half 18 of the vehicle 10 (as taken along a vertical axis passing through the centroid 14) is positioned against the right edge of the obstacle 12 as a first side boundary 20 (FIG. 4B). A second half 22 of the vehicle 10 (as taken along a vertical axis passing through the centroid 14) is positioned against the left edge of the obstacle 12 as a second side boundary 24 (FIG. 4C).

A bottom half 26 of the vehicle 10 (as taken along a horizontal axis passing through the centroid 14) is positioned against the bottom edge of the obstacle 12 as a bottom side boundary 28 (FIG. 4D). A top half 30 of the vehicle 10 (as taken along a horizontal axis passing through the centroid 14) is positioned against the top edge of the obstacle 12 as a top side boundary 32 (FIG. 4E). The first and second side boundaries 20, 24 and the bottom and top side boundaries 28, 32 are combined to form an area, a perimeter of which defines an inflated obstacle boundary 34. The boundary 34 defines the minimum distance along which the centroid 14 of the vehicle 10 can pass without colliding with the obstacle 12. If the centroid 14 of the vehicle 10 passes over the boundary 34 and into the area defined by the first and second side boundaries 20, 24 and the bottom and top side boundaries 28, 32, a collision will occur between the vehicle 10 and the obstacle 12.

As illustrated in FIG. 4E, the inflated perimeter or boundary 34 of the obstacle 12 is equal to the path that the vehicle’s 10 centroid 14 tracks when the vehicle 10 is moved around the perimeter of the obstacle 12 with the centroid 14 as close to the obstacle 12 boundary as possible at all times. However, to perform this type of boundary 34 generation, the vehicle 10 must always be parallel or nearly parallel to the road and other vehicles, and the vehicle 10 must be a single solid body where all points on the vehicle 10 move together. This creates limitations in collision boundary checking for autonomous vehicles, which can be in non-parallel and non-perpendicular orientations relative to obstacles, and can have multi-body structures. The exemplary system discussed herein allows for generating an inflated obstacle boundary for vehicles in any position and having both single and multi-body structures.

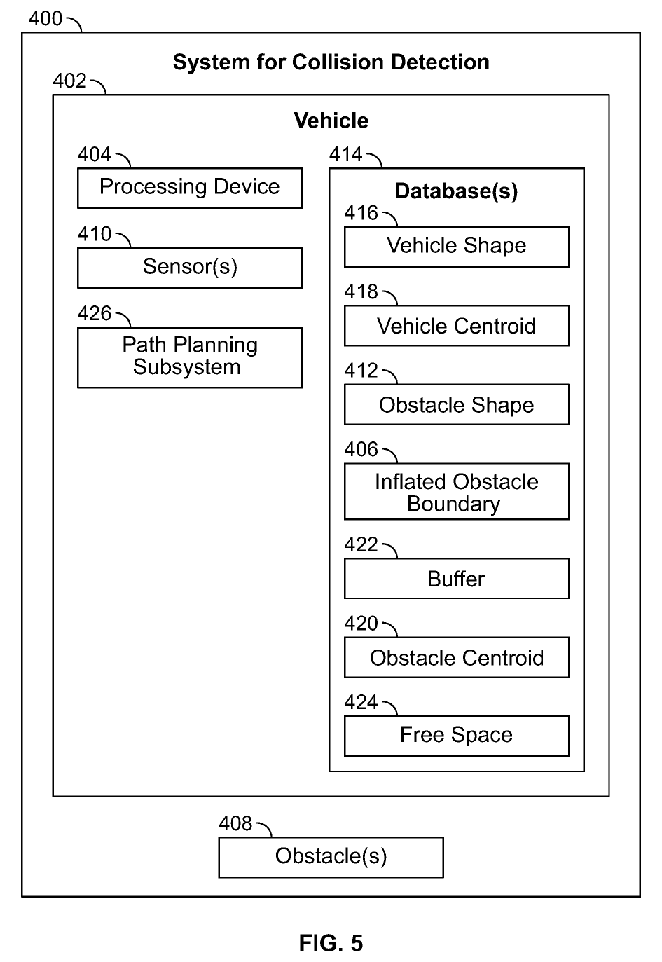

FIG. 5 is a block diagram of an exemplary system 400 for collision detection. The system 400 generally includes one or more vehicles 402 (e.g., autonomous vehicle 100). Each vehicle 402 includes a processing device 404 (e.g., computing system 200, computing system 300, or the like) configured to receive and process data for determining and generating an inflated obstacle boundary 406 for one or more obstacles 408 around the vehicle 402. At least some of the data received by the processing device 404 can be data from one or more sensors 410 (e.g., sensors 202). For example, the sensors 410 can detect obstacles 408 around the vehicle 402 and the processing device 404 can generate an obstacle shape 412 representative of the obstacle 408 depending on the shape of the obstacle 408.

The vehicle 402 can include one or more databases 414 (e.g., memory 306) configured to receive and electronically store data. In some embodiments, the database 414 can be stored externally from the vehicle 402 and the vehicle 402 can be in communication with the external database 414 for receiving and/or transmitting data associated with the system 400. The database 414 can include dimensions associated with a vehicle shape 416, e.g., a rectangle or square representative of the vehicle shape 416. The database 414 can include the coordinates associated with the position of the vehicle centroid 418. The database 414 can similarly include coordinates associated with the position of the obstacle centroid 420. The system 400 uses this data to generate an inflated obstacle boundary 406 for the obstacle 408 to avoid a collision between the vehicle 402 and the obstacle 408. The system 400 can generate a buffer 422 for the inflated obstacle boundary 406 to ensure the collision between the vehicle 402 and the obstacle 408 is avoided with additional room for movement to avoid the collision. The points outside of the buffer 422 and the inflated obstacle boundary 406 are can be identified as free space 424 through which the vehicle 402 can travel without colliding with obstacles 408. A path planning subsystem 426 of the vehicle 402 can use the free space 424 to plan a safe path for the vehicle 402 along which collisions are avoided. Steps of generating the inflated obstacle boundary for single and multi-body vehicles are discussed below.

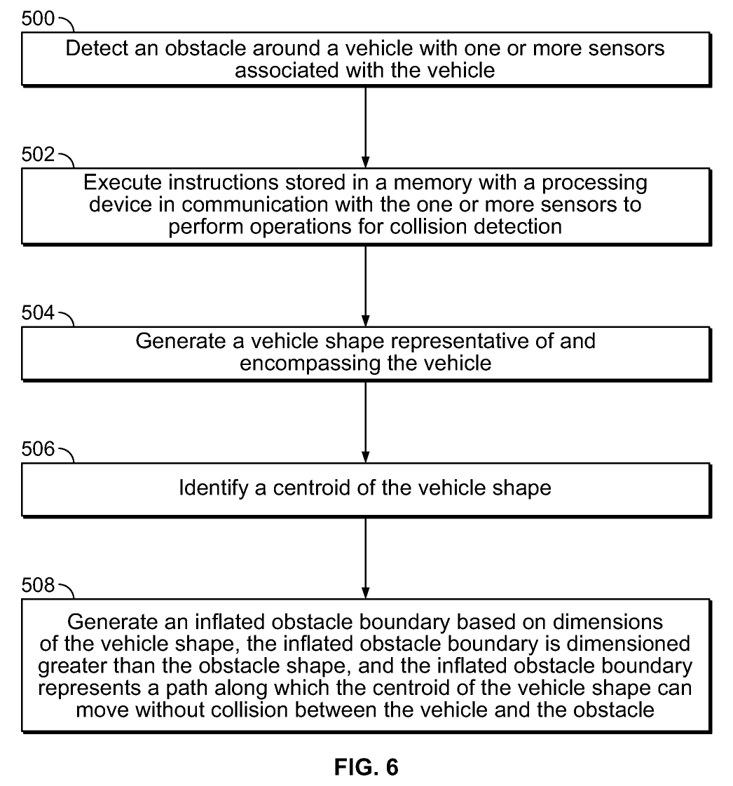

FIG. 6 is a flowchart of a method of collision detection by the exemplary system 400 discussed herein. At step 500, an obstacle is detected around a vehicle with one or more sensors associated with the vehicle. At step 502, instructions stored in a memory are executed with a processing device in communication with the one or more sensors to perform operations for obstacle detection. At step 504, these operations include generating a vehicle shape representative of and encompassing the vehicle. At step 506, the operations include identifying a centroid of the vehicle shape. At step 508, an inflated obstacle boundary is generated based on dimensions of the vehicle shape.

The inflated obstacle boundary is dimensioned greater than the obstacle shape. The inflated obstacle boundary represents a path along which the centroid of the vehicle shape can move without collision between the vehicle and the obstacle. After the inflated obstacle boundary is generated, in some embodiments, a buffer section can be added to the inflated obstacle boundary. After the buffer is added, the system can generate a command or instructions for controlling motion of the vehicle (e.g., turning, accelerating, decelerating, stopping completely, or the like) to avoid a collision with the obstacle.

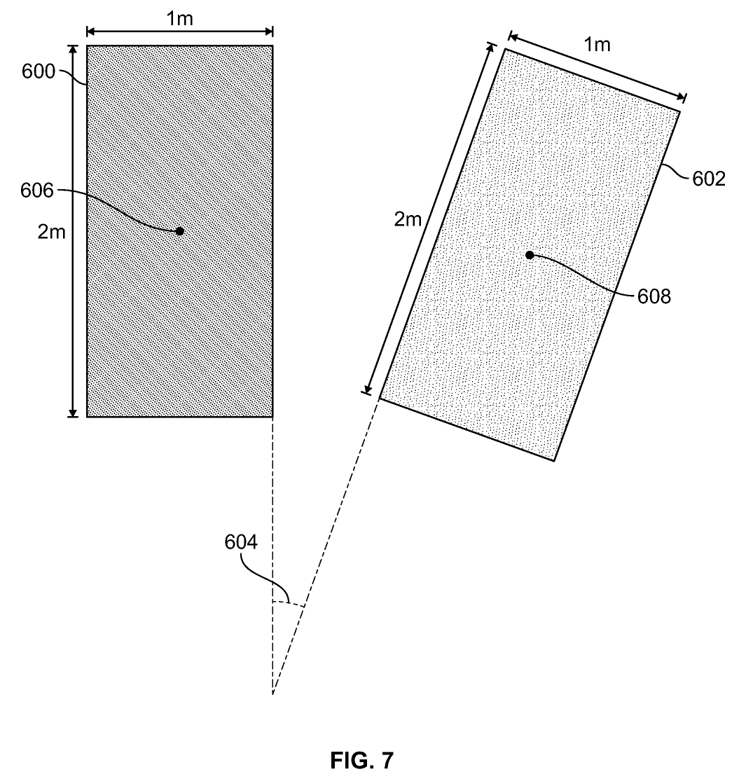

FIG. 7 is a diagrammatic view of an obstacle 600 and a single-body vehicle 602 positioned at a non-parallel and a non-perpendicular angle 604 relative to each other. A centroid 606 is assigned to the obstacle 600 shape (in this case the center along both x and y axes), and a centroid 608 is assigned to the vehicle 602 shape (in this case the center along both x and y axes). In this example, both the obstacle 600 and the vehicle 602 shapes have dimensions of 2 m in length and 1 m in width.

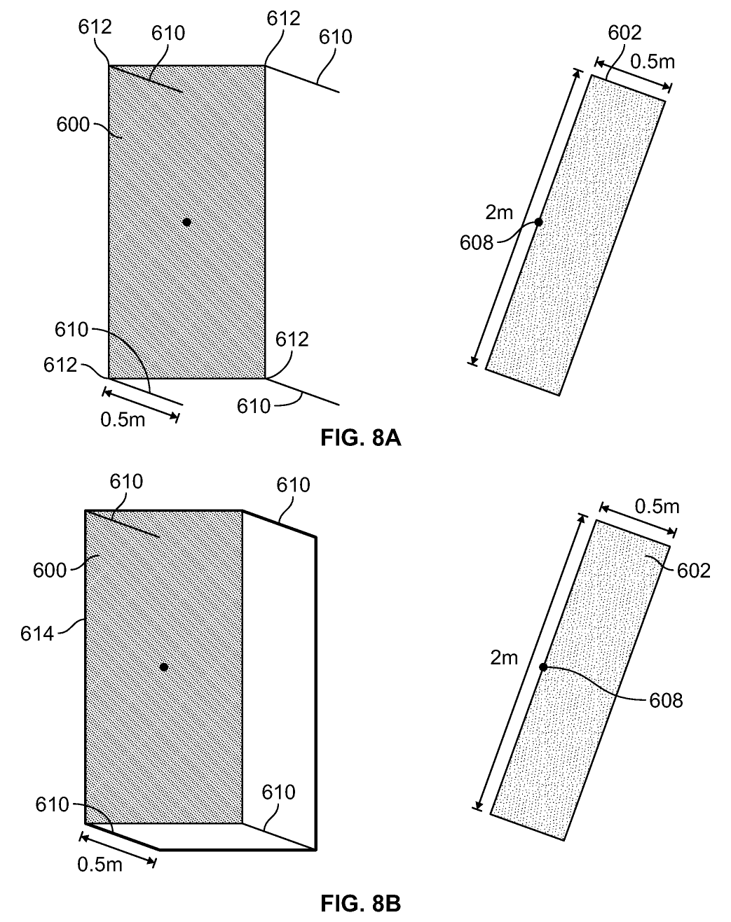

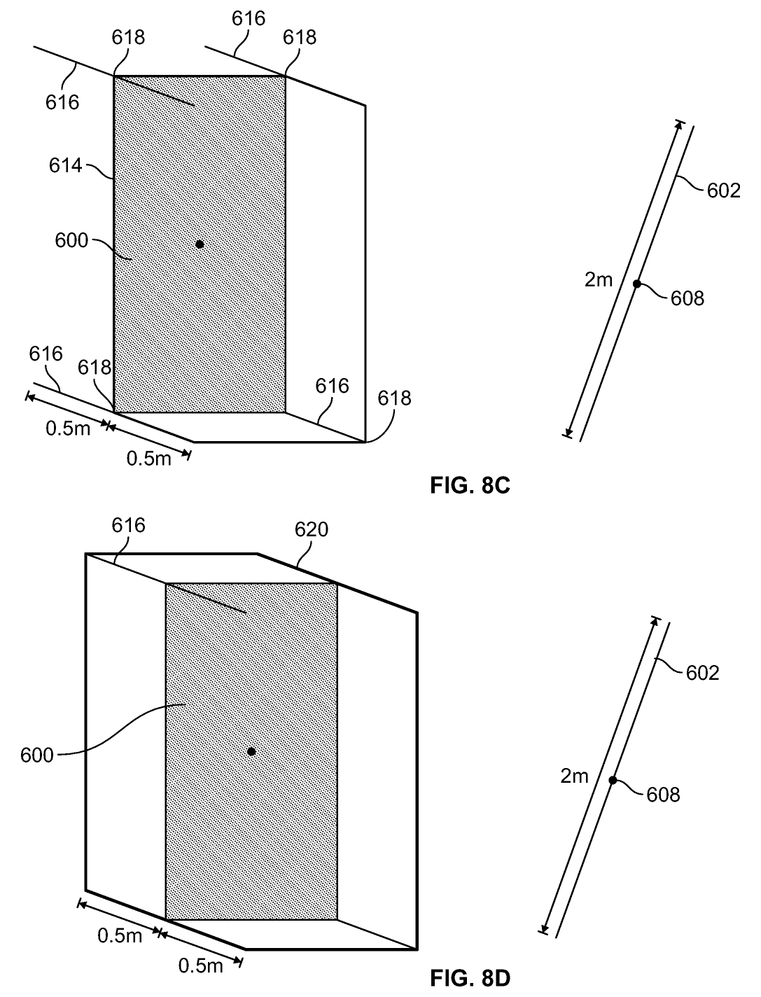

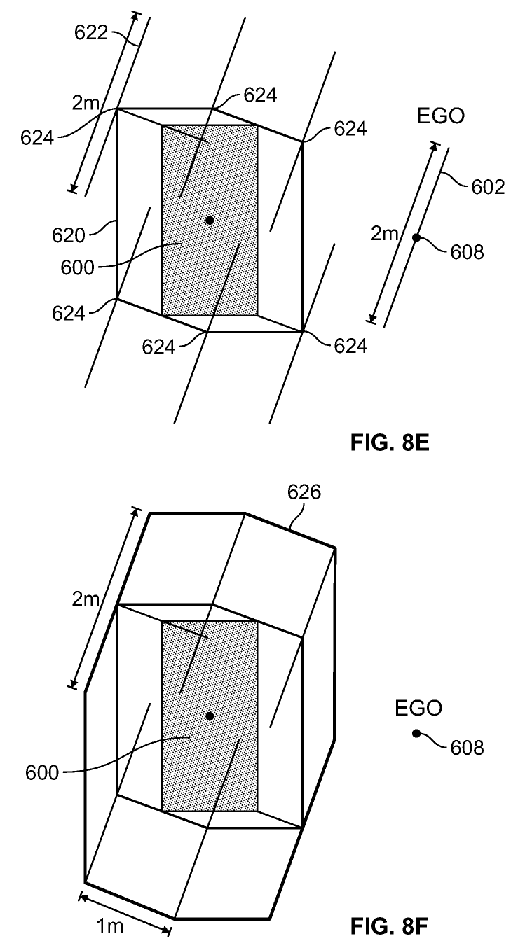

FIGS. 8A-8F are diagrammatic steps of generating an inflated obstacle boundary for the obstacle 600 and based on the vehicle 602 of FIG. 7. First, the complementary expansion that corresponds to the left half of the vehicle 602 can be obtained by drawings/generating lines 610 parallel to the top and bottom edges of the vehicle 602 from each vertex 612 of the obstacle 600. (See FIG. 8A). Because the expansion is focused only on the left half side of the vehicle 602, the length of each line 610 is half of the width of the vehicle 602, i.e., 0.5 m in this example. As illustrated in FIG. 8A, the left half of the vehicle 602 is formed by an axis or plane extending through the centroid 608 and parallel to the side edges of the vehicle 602. An intermediate or first part 614 of the inflated obstacle boundary is generated by connecting the outermost end points of the lines 610, the edges of the lines 610, edges of the obstacle 600, and the vertices 612 of the obstacle 600. (See FIG. 8B). Any lines 610 that fall within the boundaries of the obstacle 600 are ignored, e.g., top left corner. The vehicle 602 is reduced to only its right half.

Next, the same operation is performed for the right half of the vehicle 602. Lines 616 are drawn/generated parallel to the top and bottom edges of the vehicle 602 from each vertex 618 of the first part 614 of the inflated obstacle boundary. (See FIG. 8C). Because the expansion is focused only on the right half side of the vehicle 602, the length of each line 616 is half of the width of the vehicle 602, i.e., 0.5 m in this example. Similar to the left half, the right half of the vehicle 602 is formed by an axis or plane extending through the centroid 608 and parallel to the side edges of the vehicle 602. An intermediate or second part 620 of the inflated obstacle boundary is generated by connecting the outermost end points of the lines 616, the edges of the first part 614 of the inflated obstacle boundary, and vertices of the first part 614 of the inflated obstacle boundary. (See FIG. 8D). Any lines 616 that fall within the boundaries of the first part 614 of the inflated obstacle boundary are ignored, e.g., bottom right corner. The vehicle 602 is reduced to a straight line along its length passing through the centroid 608.

Now the system can perform similar steps based on the top and bottom halves of the vehicle 602. Lines 622 are drawn/generated parallel to the left and right sides of the vehicle 602 from each vertex 624 of the second part 620 of the inflated obstacle boundary. (See FIG. 8E). Although this step could be split into the top and bottom halves of the vehicle 602, in the example shown in FIG. 8E, the lines 622 are dimensioned equal to the entire length of the vehicle 602, i.e., 2 m, with the centroid 608 associated with the lines 622 positioned at each respective vertex 624. The final inflated obstacle boundary 626 is generated by connecting the outermost end points of the lines 622, the edges of the second part 620 of the inflated obstacle boundary, and vertices of the second part 620 of the inflated obstacle boundary. (See FIG. 8F). Any portion of the lines 622 that fall within the second part 620 of the inflated obstacle boundary are ignored.

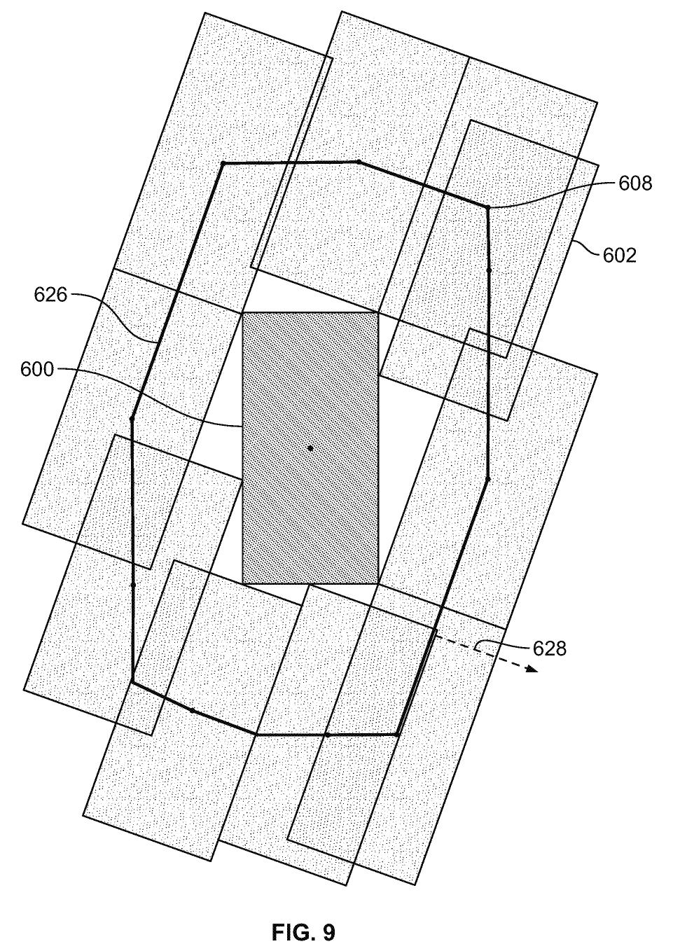

FIG. 9 is a diagrammatic view of the inflated obstacle boundary 626 generated by the system for the vehicle 602 relative to the obstacle 600. The inflated obstacle boundary 626 creates a pathway around the obstacle 600 and defines an internal area that the centroid 608 of the vehicle 602 cannot enter. In particular, the boundary 626 represents how far the centroid 608 can pass before the vehicle 602 collides with the obstacle 600. Instances of the vehicle 602 are shown along the pathway formed by the inflated obstacle boundary 626, with the centroid 608 positioned along the pathway. The inflated obstacle boundary 626 thereby defines the minimum distance the vehicle 602 can be positioned relative to the obstacle 600 without a collision taking place. It should be understood that any change in position of the vehicle 602 relative to the obstacle 600 would necessitate a recalculation or regeneration of the inflated obstacle boundary 626, since the boundary 626 would change depending on the position of the vehicle 602 relative to the obstacle 600.

In some embodiments, to ensure that a collision is avoided, the system can add a buffer in direction 628 around the entire perimeter of the inflated obstacle boundary 626. The direction 628 for the buffer is perpendicular to each respective line and the dimension or distance of the buffer can be determined on a case-by-case basis depending on a number of factors, e.g., the type of obstacle, the location of the obstacle relative to the vehicle, the speed of the vehicle, or the like. For example, if the vehicle 602 is traveling at a high speed, the size of the buffer can be increased to ensure a collision with the obstacle 600 is avoided. The overall shape of the buffered inflated obstacle boundary is the same as the inflated obstacle boundary 626. However, the overall area of the buffered boundary is greater than the boundary 626.

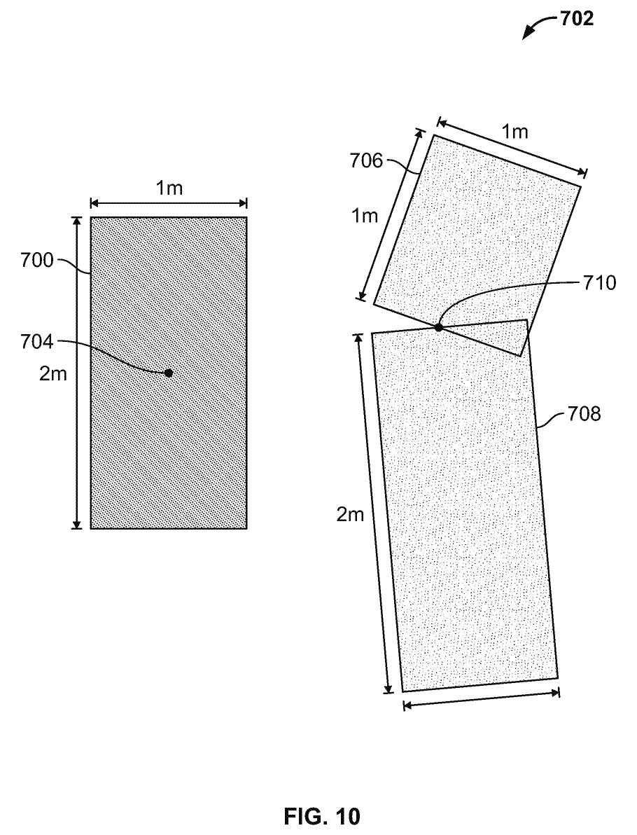

FIG. 10 is a diagrammatic view of an obstacle 700 and a multi-body vehicle 702 positioned at a non-parallel and a non-perpendicular angle relative to the obstacle 700. A centroid 704 is assigned to the obstacle 700 shape (in this case the center along both x and y axes). The multi-body vehicle 702 includes a first section 706 (e.g., a tractor or truck) coupled to a second section 708 (e.g., a trailer). A centroid 710 is assigned to the vehicle 702 and is located at the connection or hitch point between the first and second sections 706, 708 (e.g., not the center of the sections 706, 708). However, the centroid position could be chosen anywhere for the vehicle 702. In this example, the obstacle 700 shape is 2 m in length and 1 m in width, while the first section 706 of the vehicle 702 is 1 m in length and 1 m in width, and the second section 708 of the vehicle 702 is 2 m in length and 1 m in width.

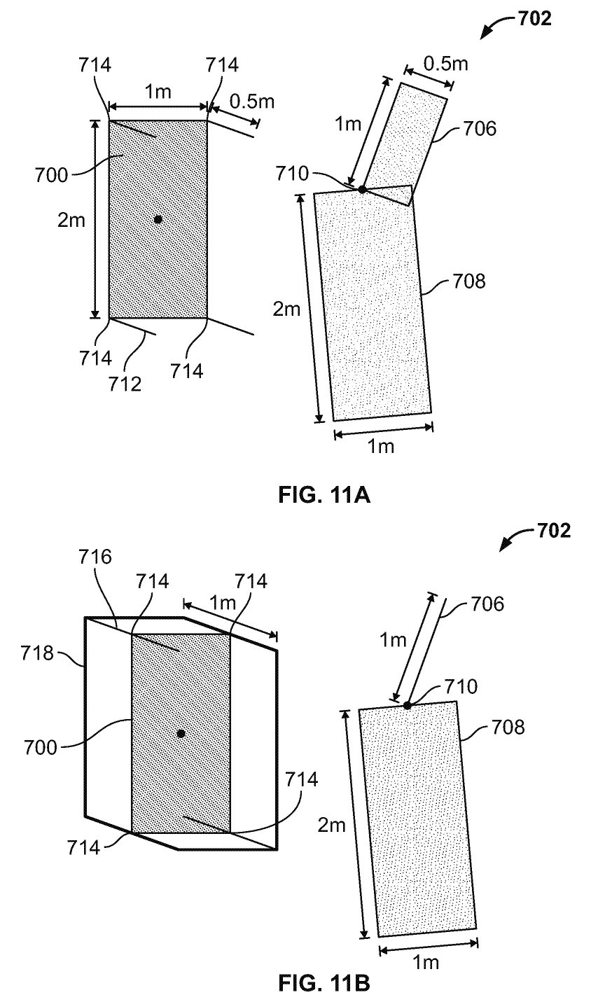

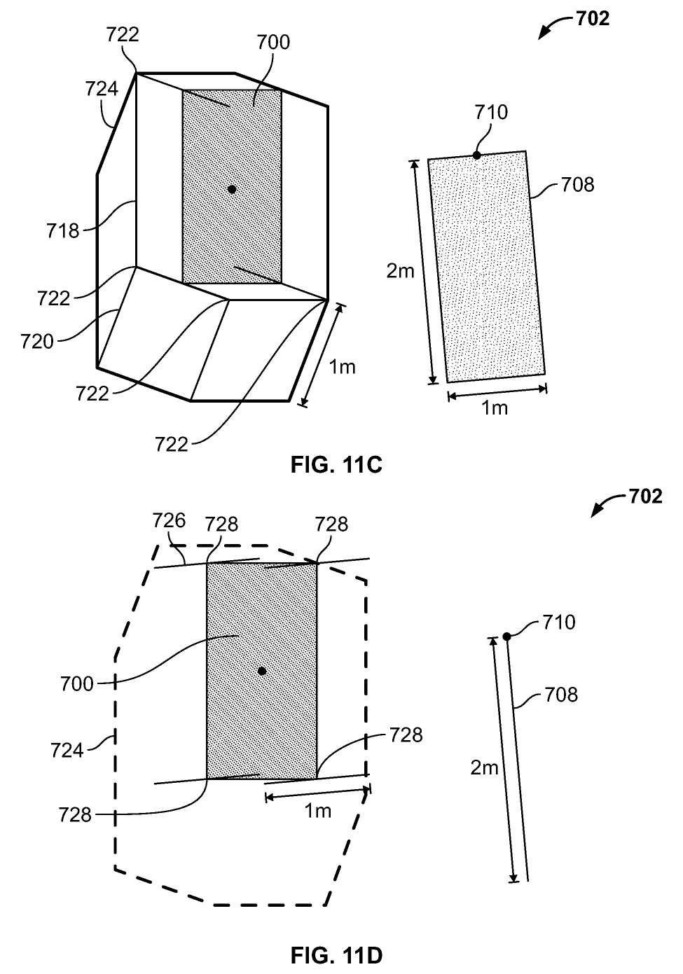

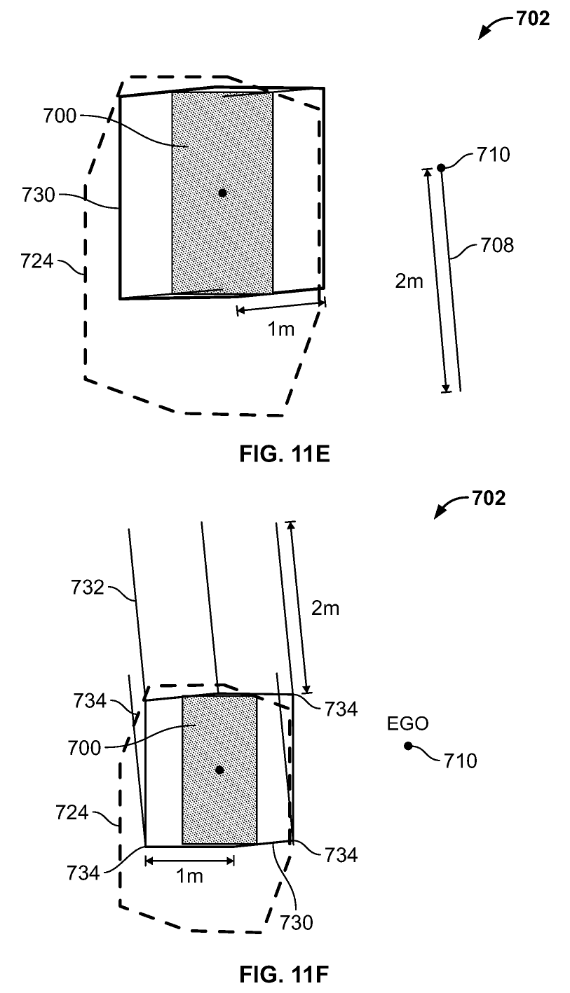

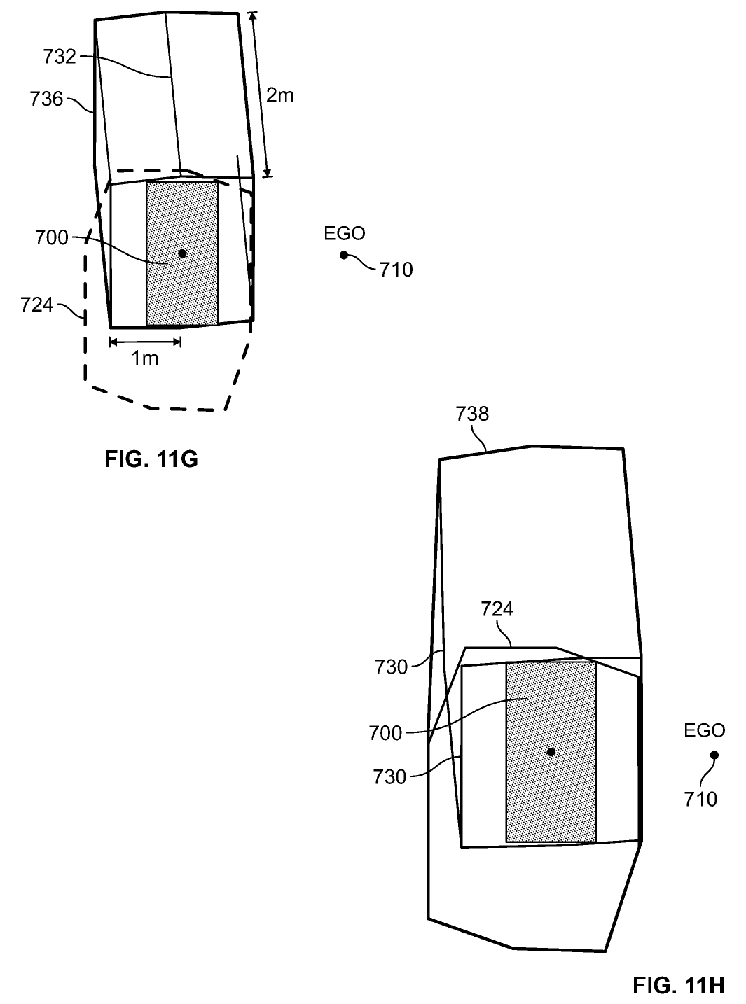

FIGS. 11A-11H are diagrammatic steps of generating an inflated obstacle boundary for the obstacle 700 based on the vehicle 702 of FIG. 10. The inflated obstacle boundary can first be generated for the first section 706 of the vehicle 702, and subsequently generated for the second section 708 of the vehicle 702, with both inflated obstacle boundaries combined defining the “final” obstacle boundary for the entire vehicle 702. The obstacle boundary determination can therefore be made for the tractor (the first section 706) and the trailer (the second section 708), instead of top and bottom halves/sections of the vehicle 702.

Focusing on the first section 706, lines 712 dimensioned half of the full width of the first section 706 (i.e., 0.5 m) are generated at each of the vertices 714 of the obstacle 700. (See FIG. 11A). Additional lines 716 dimensioned half of the full width of the first section 706 (i.e., 0.5 m) are generated at each of the vertices 714 of the obstacle 700 and extend in the opposite direction of the lines 712. (See FIG. 11B). In some embodiments, lines dimensioned the full width of the first section 706 (i.e., 1 m) could be generated at each of the vertices 714, with the center of each line positioned at the respective vertex 714, thereby extending into both directions from the vertex 714 by half the width (i.e., 0.5 m) to achieve the lines in FIG. 11B. The lines 712, 716 are parallel to the top and bottom edges of the first section 706. An intermediate or first part 718 of the inflated obstacle boundary is generated by connecting the endpoints of the lines 712, 716, the edges of the lines 712, 716, the vertices 714 of the obstacle 700, and edges of the obstacle 700. Any lines within the area of the first part 718 are ignored. This reduces the vehicle 702 to a line.

In order to address the length of the vehicle 702, thereby reducing the vehicle 702 to a point at the centroid 710, lines 720 are generated at each of the vertices 722 of the first part 718 of the inflated obstacle boundary. (See FIG. 11C). The lines 720 are dimensioned the full length of the vehicle 702 (i.e., 1 m) and extend parallel to the side edges of the vehicle 702. The lines 720 extend in a direction opposite from the direction of extension from the centroid 710 (because the first section 706 extends completely on one side of the centroid 710). For example, as illustrated in FIG. 11C, the side edges (or line in FIG. 11B) extends upward from the centroid 710; the lines 720 therefore extend downward from the respective vertices 722. An intermediate or second part 724 of the inflated obstacle boundary is generated by connecting the endpoints of the lines 720, the edges of the lines 720, the vertices 722 of the first part 718, and the edges of the first part 718. Any lines within the area of the second part 724 are ignored. This reduces the vehicle 702 to a point. The part 724 defines a perimeter or path along which the centroid 710 can pass without creating a collision between the first section 706 of the vehicle 702 and the obstacle 700. The process is repeated for the second section 708 of the vehicle 702, as discussed below.

In generating the inflated obstacle boundary for the second section 708 of the vehicle 702, the second part 724 for the first section 706 can be ignored and later combined with the boundary created for the second section 708. In addressing the width of the second section 708, lines 726 are generated at each of the vertices 728 of the obstacle 700. (See FIG. 11D). The lines 726 are dimensioned the full width (i.e., 1 m), with the center of the lines 726 positioned at each respective vertex 728. The lines 726 extend parallel to the top and bottom edges of the second section 708. An intermediate or first part 730 of the inflated obstacle boundary is generated by connecting the endpoints of the lines 726, the edges of the lines 726, the vertices 728, and the edges of the obstacle 700. (See FIG. 11E). Any lines within the first part 730 are ignored. This reduces the second section 708 to a line.

To address the length of the second section 708, lines 732 are generated at each of the vertices 734 of the first part 730 of the inflated obstacle boundary. (See FIG. 11F). The lines 732 are dimensioned the full length of the second section 708 (i.e., 2 m), and extend only in one direction because the second section 708 extends only on one side of the centroid 710 of the vehicle 702. Similar to the first section 706, the lines 732 extend in the opposite direction from the vertices 734 as compared to the extension of the second section 708 from the centroid 710 (e.g., upward vs downward). The lines 732 extend parallel to the side edges of the second section 708. An intermediate or second part 736 of the inflated obstacle boundary is generated by connecting the endpoints of the lines 732, the edges of the lines 732, the vertices 734, and the edges of the first part 730. (See FIG. 11G). Any lines within the second part 736 are ignored. This reduces the second section 708 to a point at the centroid 710. The second part 736 defines the inflated obstacle boundary pathway along which the centroid 710 of the vehicle 702 can travel without a collision between the second section 708 and the obstacle 700.

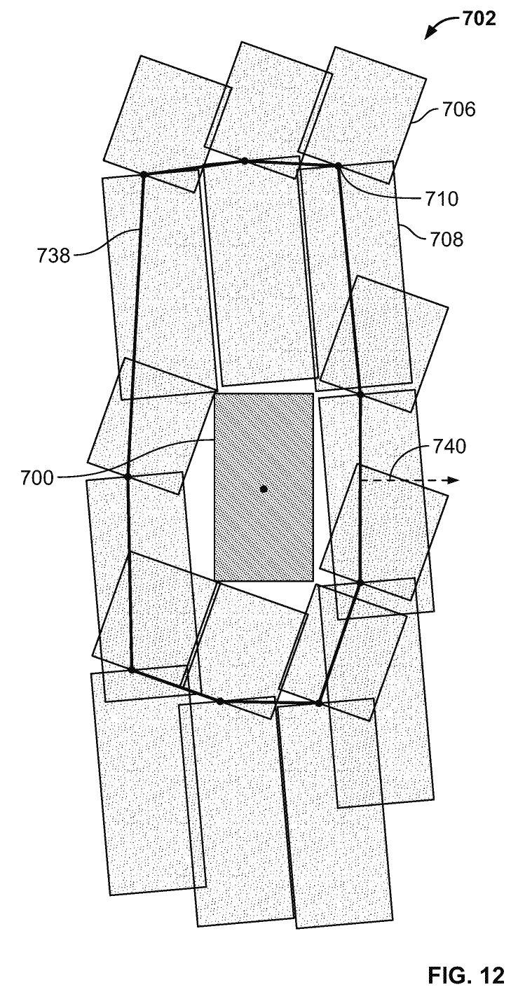

As a final step, the system combines the second part 724 boundary for the first section 706 of the vehicle 702 and the second part 736 boundary for the second section 708 of the vehicle 702, resulting in a final combined inflated obstacle boundary 738. (See FIGS. 11H and 12). The boundary 738 defines the closest pathway along which the centroid 710 of the vehicle 702 can travel without a collision between the vehicle 702 (both first and second sections 706, 708) and the obstacle 700. In some embodiments, a buffer can be added around the boundary 738 in a direction 740 perpendicular to the respective lines of the boundary 738 to create more space between the vehicle 702 and the obstacle 700 to avoid chances of a collision. The shape of the buffered inflated obstacle boundary is the same as the boundary 738, but the overall area of the buffered boundary is greater than the boundary 738.

The buffered boundary can be recalculated by the system with each movement of the vehicle 702, whether movement of only the first section 706, the second section 708, or both. Based on the boundary generated by the system, movement of the vehicle 702 can be controlled to avoid a collision with the obstacle 700. The system can thereby generate an obstacle boundary that allows for controlled and safe operation of the vehicle 702, with the vehicle 702 planning a path around this obstacle boundary for collision-free travel.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for collision detection, comprising:
one or more sensors associated with a vehicle, the one or more sensors configured to detect an obstacle around the vehicle; and
a processing device in communication with the one or more sensors, the processing device is configured to execute instructions stored in a memory to perform operations comprising:
generating a vehicle shape representative of and encompassing the vehicle;
identifying a centroid of the vehicle shape;
generating an obstacle shape representative of and encompassing the obstacle; and
generating an inflated obstacle boundary based on dimensions of the vehicle shape;
wherein the inflated obstacle boundary is dimensioned greater than the obstacle shape; and
wherein the inflated obstacle boundary represents a path along which the centroid of the vehicle shape can move without collision between the vehicle and the obstacle.

2. The system of claim 1, wherein the vehicle is at a non-parallel and non-perpendicular angle relative to the detected obstacle, and wherein the vehicle is a single body vehicle or a multi-body vehicle including a tractor and a trailer.

3. The system of claim 1, wherein the vehicle shape is a vehicle rectangle or square including a top edge and an opposing bottom edge defining a width, and a left edge and an opposing right edge defining a length, and wherein the obstacle shape is an obstacle rectangle or square including a top edge and an opposing bottom edge defining a width, a left edge and an opposing right edge defining a length, and a vertex at each corner of the obstacle rectangle or square.

4. The system of claim 3, wherein generating the inflated obstacle boundary comprises:
transposing a first set of lines having a dimension of half the width and extending in a direction parallel to the top and bottom edges of the vehicle rectangle or square from each vertex of the obstacle rectangle or square;
connecting endpoints of the first set of lines with a boundary of the obstacle shape to represent a first part of the inflated obstacle boundary;
transposing a second set of lines having a dimension of half the width and extending in the direction parallel to the top and bottom edges of the vehicle rectangle or square from each vertex of the obstacle rectangle or square, wherein the second set of lines extend from the vertex away from the respective first set of lines; and
connecting endpoints of the second set of lines with the first part of the inflated obstacle boundary to represent a second part of the inflated obstacle boundary.

5. The system of claim 4, wherein generating the inflated obstacle boundary comprises:
transposing a third set of lines having a dimension of half the length and extending in a direction parallel to the left and right edges of the vehicle rectangle or square from each vertex of the second part of the inflated obstacle boundary;
transposing a fourth set of lines having a dimension of half the length and extending in a direction parallel to the left and right edges of the vehicle rectangle or square from each vertex of the second part of the inflated obstacle boundary, wherein the fourth set of lines extend from the vertex away from the respective third set of lines; and
connecting endpoints of the third and fourth set of lines with the second part of the inflated obstacle boundary to represent the inflated obstacle boundary.

6. The system of claim 1, wherein:
if the vehicle is a single body vehicle, the operations comprise generating the inflated obstacle boundary based on only the vehicle shape; and
if the vehicle is a multi-body vehicle, the operations comprise:
generating the vehicle shape for each body of the multi-body vehicle;
generating the inflated obstacle boundary based on each vehicle shape; and
combining the inflated obstacle boundaries based on each vehicle shape to generate a multi-body inflated obstacle boundary.

7. The system of claim 1, wherein if the vehicle is a multi-body vehicle, generating the vehicle shape comprises:
generating a first vehicle shape for a first section of the multi-body vehicle; and
generating a second vehicle shape for a second section of the multi-body vehicle;
wherein each of the first vehicle shape and the second vehicle shape is a vehicle rectangle or square including a top edge and an opposing bottom edge defining a width, and a left edge and an opposing right edge defining a length; and
wherein the obstacle shape is an obstacle rectangle or square including a top edge and an opposing bottom edge defining a width, a left edge and an opposing right edge defining a length, and a vertex at each corner of the obstacle rectangle or square.

8. The system of claim 7, wherein if the vehicle is a multi-body vehicle, the centroid is located at an intersection or connection of the first vehicle shape and the second vehicle shape.

9. The system of claim 7, wherein if the vehicle is the multi-body vehicle, generating the inflated obstacle boundary comprises:
generating a first inflated obstacle boundary based on the first vehicle shape;
generating a second inflated obstacle boundary based on the second vehicle shape; and
combining the first and second inflated obstacle boundaries to generate a multi-body inflated obstacle boundary.

10. The system of claim 9, wherein generating the first inflated obstacle boundary comprises:
transposing a first set of lines having a dimension of half the width of the first vehicle shape and extending in a direction parallel to the top and bottom edges of the vehicle rectangle or square for the first vehicle shape from each vertex of the obstacle rectangle or square;
connecting endpoints of the first set of lines with a boundary of the obstacle shape to represent a first part of the first inflated obstacle boundary;
transposing a second set of lines having a dimension of the width of the first vehicle shape and extending in the direction parallel to the top and bottom edges of the vehicle rectangle or square for the first vehicle shape from each vertex of the obstacle rectangle or square, wherein the second set of lines extend from the vertex away from the respective first set of lines; and
connecting endpoints of the second set of lines with the first part of the first inflated obstacle boundary to represent a second part of the first inflated obstacle boundary.

11. The system of claim 10, wherein generating the first inflated obstacle boundary comprises:
transposing a third set of lines having a dimension of the length of the first vehicle shape and extending in a direction parallel to the left and right edges of the vehicle rectangle or square for the first vehicle shape from each vertex of the second part of the first inflated obstacle boundary; and
connecting endpoints of the third set of lines with the second part of the first inflated obstacle boundary to represent the first inflated obstacle boundary.

12. The system of claim 12, wherein generating the second inflated obstacle boundary comprises:
transposing a first set of lines having a dimension of half the width of the second vehicle shape and extending in a direction parallel to the top and bottom edges of the vehicle rectangle or square for the second vehicle shape from each vertex of the obstacle rectangle or square;
connecting endpoints of the first set of lines with a boundary of the obstacle shape to represent a first part of the second inflated obstacle boundary;
transposing a second set of lines having a dimension of the width of the second vehicle shape and extending in the direction parallel to the top and bottom edges of the vehicle rectangle or square for the second vehicle shape from each vertex of the obstacle rectangle or square, wherein the second set of lines extend from the vertex away from the respective first set of lines; and
connecting endpoints of the second set of lines with the first part of the second inflated obstacle boundary to represent a second part of the second inflated obstacle boundary.

13. The system of claim 12, wherein generating the second inflated obstacle boundary comprises:
transposing a third set of lines having a dimension of the length of the second vehicle shape and extending in a direction parallel to the left and right edges of the vehicle rectangle or square for the second vehicle shape from each vertex of the second part of the second inflated obstacle boundary; and
connecting endpoints of the third set of lines with the second part of the second inflated obstacle boundary to represent the second inflated obstacle boundary.

14. The system of claim 1, wherein:
the operations further comprise generating a buffer zone along a perimeter of the inflated obstacle boundary;
the buffer zone is an area offset perpendicularly from each side of the inflated obstacle boundary by a predetermined distance away from the obstacle; and
the operations further comprise setting a border of the buffer zone as a limit for travel of the centroid of the vehicle shape to avoid the collision between the vehicle and the obstacle.

15. The system of claim 1, wherein the operations further comprise setting or adjusting a motion path of the vehicle to avoid entering or passing of the centroid of the vehicle shape through the inflated obstacle boundary to avoid the collision between the vehicle and the obstacle.

16. A computer-implemented method for collision detection, comprising:
detecting an obstacle around a vehicle with one or more sensors associated with the vehicle; and
executing instructions stored in a memory with a processing device in communication with the one or more sensors to perform operations comprising:
generating a vehicle shape representative of and encompassing the vehicle;
identifying a centroid of the vehicle shape;
generating an obstacle shape representative of and encompassing the obstacle; and
generating an inflated obstacle boundary based on dimensions of the vehicle shape;
wherein the inflated obstacle boundary is dimensioned greater than the obstacle shape; and
wherein the inflated obstacle boundary represents a path along which the centroid of the vehicle shape can move without collision between the vehicle and the obstacle.

17. The computer-implemented method of claim 16, wherein:
the vehicle shape is a vehicle rectangle or square including a top edge and an opposing bottom edge defining a width, and a left edge and an opposing right edge defining a length; and
the obstacle shape is an obstacle rectangle or square including a top edge and an opposing bottom edge defining a width, a left edge and an opposing right edge defining a length, and a vertex at each corner of the obstacle rectangle or square.

18. The computer-implemented method of claim 17, wherein generating the inflated obstacle boundary comprises:
transposing a first set of lines having a dimension of half the width and extending in a direction parallel to the top and bottom edges of the vehicle rectangle or square from each vertex of the obstacle rectangle or square; and
connecting endpoints of the first set of lines with a boundary of the obstacle shape to represent a first part of the inflated obstacle boundary.

19. The computer-implemented method of claim 18, wherein generating the inflated obstacle boundary comprises:
transposing a second set of lines having a dimension of half the width and extending in the direction parallel to the top and bottom edges of the vehicle rectangle or square from each vertex of the obstacle rectangle or square, wherein the second set of lines extend from the vertex away from the respective first set of lines; and
connecting endpoints of the second set of lines with the first part of the inflated obstacle boundary to represent a second part of the inflated obstacle boundary.

20. The computer-implemented method of claim 19, wherein generating the inflated obstacle boundary comprises:
transposing a third set of lines having a dimension of half the length and extending in a direction parallel to the left and right edges of the vehicle rectangle or square from each vertex of the second part of the inflated obstacle boundary;
transposing a fourth set of lines having a dimension of half the length and extending in a direction parallel to the left and right edges of the vehicle rectangle or square from each vertex of the second part of the inflated obstacle boundary, wherein the fourth set of lines extend from the vertex away from the respective third set of lines; and
connecting endpoints of the third and fourth set of lines with the second part of the inflated obstacle boundary to represent the inflated obstacle boundary.
